(19) United States
(12) Patent Application Publication
(10) Pub. No.: US 2017/0085302 A1
(43) Pub. Date: Mar. 23, 2017

(54) WIRELESS COMMUNICATION DEVICE AND METHOD OF CONTROLLING SIGNAL PROCESSING

(71) Applicant: KYOCERA Corporation, Kyoto-shi (JP)

(72) Inventors: Fangwei TONG, Tokyo (JP); Chiharu YAMAZAKI, Tokyo (JP)

(21) Appl. No.: 15/371,222

(22) Filed: Dec. 7, 2016

Related U.S. Application Data
(63) Continuation of application No. PCT/JP2015/065981, filed on Jun. 3, 2015.

(30) Foreign Application Priority Data
Jun. 9, 2014 (JP) 2014-118353

(51) Int. Cl. H04B 7/04; H04L 5/00; H04L 1/16

(52) U.S. Cl. CPC H04B 7/04; H04L 1/16; H04L 5/0048

(57) ABSTRACT

A wireless communication device for performing communication with a controlled wireless communication device includes a controller configured to estimate channel quality of a channel used in feedback of a signal from the controlled wireless communication device and control weighting of a transmission signal in consideration of the estimated channel quality. The controller stores multiple methods of generating a transmission antenna weight that is used in the weighting of the transmission signal, and performs the weighting of the transmission signal by switching among the multiple methods of generating a transmission antenna weight on the basis of the estimated channel quality.

### CROSS-REFERENCE TO RELATED APPLICATION

The present application is a continuation based on PCT Application No. PCT/JP2015/065981 filed on Jun. 3, 2015, which claims the benefit of Japanese Patent Application No. 2014-118353 filed on Jun. 9, 2014. PCT Application No. PCT/JP2015/065981 is entitled “WIRELESS COMMUNICATIONS DEVICE AND METHOD FOR CONTROLLING SIGNAL PROCESSING” and Japanese Patent Application No. 2014-118353 is entitled “WIRELESS COMMUNICATIONS DEVICE AND METHOD OF CONTROLLING SIGNAL PROCESSING”. The contents of which are incorporated by reference herein in their entirety.

### FIELD

Embodiments of the present disclosure relate generally to wireless communication devices and in particular to wireless communication devices for performing weighting of transmission signals.

### BACKGROUND

Digital transmission systems have become the mainstream of wireless communication in recent years. Wireless communication devices that employ digital transmission systems perform various types of signal processing such as quantization, binary coding, and symbol mapping on analog data to be transmitted, when generating transmission signals from analog values.

Quantization refers to the process of replacing continuous analog values with approximate discrete values such as integers. Binary coding refers to the process of converting discrete values obtained by quantization into binary numbers (i.e., bit string). Symbol mapping refers to the process of converting (i.e., digitally modulating) a bit string obtained by binary coding into transmission symbols.

The aforementioned digital transmission systems can adopt error-correcting codes or other schemes and thus provide high resistance to noise and interference in transmission channels, but may face the problem of channel capacity shortage because the transmission bit length needs to increase in order to improve the resolution of data to be transmitted. Conversely, a short bit length that is set in consideration of channel capacity may inhibit efficient use of channel capacity and degrade resolution, despite improved channel quality and sufficient channel capacity.

Recently, consideration is being given to analog feedback, i.e., using analog transmission systems to feed back channel state information (CSI) measured by user terminals to base stations, as disclosed in “Performance of Analog Feedback in Closed-Loop Transmit Diversity Systems” by Chiu, E., Ho, P., and Jae Hyung Kim in Wireless Communications and Networking Conference, 2006, IEEE, pp. 1227-1232. The “analog transmission system” refers to the operation of converting measured channel state information directly into transmission signals without performing processing such as quantization and binary coding, and transmitting the transmission signals.

When CSI is transferred via the aforementioned analog feedback, transmission errors caused by noise and interference in uplink may not be corrected, and the reliability of the CSI received by base stations depends on channel quality (e.g., noise level). Thus, for example when in closed-loop control introduced in multiple-input multiple-output (MIMO) communication, weighting (precoding) of transmission signals is performed on the basis of the CSI as received by the base stations, not only cannot the transmission performance be made full use of, but also transmission signals may become deteriorated greatly depending on the situation.

### SUMMARY

In one embodiment, a wireless communication device according to the disclosure is a wireless communication device for performing communication with a controlled wireless communication device. The wireless communication device includes at least one processor configured to estimate channel quality of a channel that is used in feedback of a signal from the controlled wireless communication device and control weighting of a transmission signal in consideration of the estimated channel quality. The at least one processor is configured to store a plurality of methods of generating a transmission antenna weight that is used in the weighting of the transmission signal and perform the weighting of the transmission signal by switching among the plurality of methods of generating a transmission antenna weight on the basis of the estimated channel quality.

In one embodiment, a method of controlling signal processing according to the disclosure is a method of controlling signal processing performed by a wireless communication device for performing communication with a controlled wireless communication device. The method includes the steps of (a) estimating channel quality of a channel that is used in feedback of a signal from the controlled wireless communication device, and (b) performing weighting of a transmission signal in consideration of the estimated channel quality. The step (b) involves using a plurality of methods of generating a transmission antenna weight that is used in the weighting of the transmission signal, and performing the weighting of the transmission signal by switching among the plurality of methods of generating a transmission antenna weight on the basis of the estimated channel quality.

### BRIEF DESCRIPTION OF THE DRAWINGS

FIG. 1 illustrates a configuration of an LTE system according to Embodiments 1 to 3.

FIG. 2 illustrates a block diagram of a UE according to Embodiments 1 to 3.

FIG. 3 illustrates a block diagram of an eNB according to Embodiments 1 to 3.

FIG. 4 illustrates a wireless interface protocol stack in the LTE system.

FIG. 5 illustrates a configuration of a radio frame used in the LTE system.

FIG. 6 illustrates a flowchart for describing the operation of controlling weighting on the basis of an estimated value of channel quality according to Embodiment 1.

FIG. 7 illustrates a flowchart for describing the operation of controlling weighting on the basis of an estimated value of channel quality according to Embodiment 1.

FIG. 8 illustrates an example of antenna patterns with different beam widths.

FIG. 9 illustrates an example of antenna patterns with different beam widths.

FIG. 10 illustrates an example of antenna patterns with different beam widths.

FIG. 11 illustrates a flowchart for describing the operation of controlling weighting on the basis of an estimated value of channel quality according to Embodiment 2.

FIG. 12 illustrates a flowchart for describing the operation of controlling weighting on the basis of an estimated value of channel quality according to Embodiment 3.

FIG. 13 illustrates a flowchart for describing a method of dynamically adjusting the interval of channel estimation.

### DETAILED DESCRIPTION

### Introduction

Prior to descriptions of embodiments of the disclosure, Long Term Evolution (LTE) standardized by the 3rd Generation Partnership Project (3GPP) will be described.

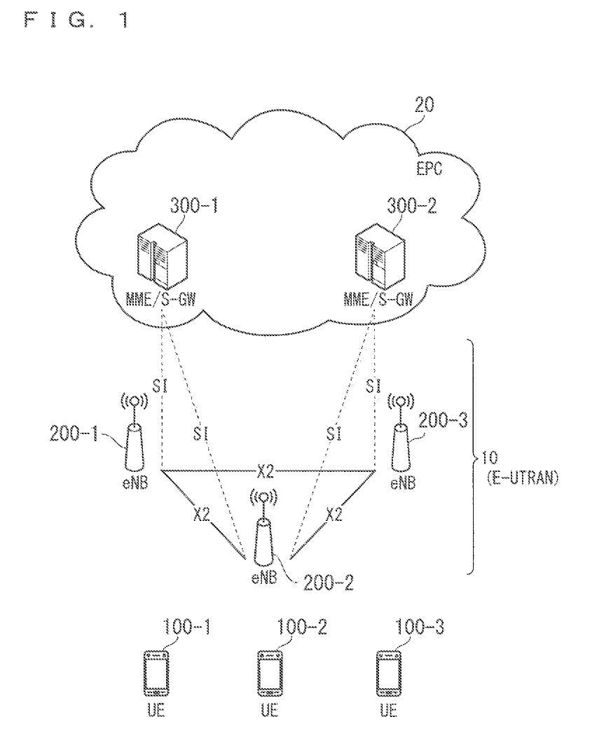

FIG. 1 illustrates a configuration of an LTE system. As illustrated in FIG. 1, the LTE system includes multiple pieces of user equipment (UEs) 100, an evolved-UMTS terrestrial radio access network (E-UTRAN) 10, and an evolved packet core (EPC) 20. The E-UTRAN 10 corresponds to a wireless access network, and the EPC 20 corresponds to a core network. The E-UTRAN 10 and the EPC 20 constitute a network of the LTE system.

The UEs 100 are mobile communication devices and can perform wireless communication with connection destination cells (serving cells). The UEs 100 correspond to user terminals.

The E-UTRAN 10 includes multiple evolved Node-Bs (eNBs) 200. The eNBs 200 correspond to base stations. Each eNB 200 can manage a single or multiple cells and perform wireless communication with UEs 100 that have connection with the cells managed by the eNB 200. The term “cell” is used not only as a term indicating the smallest unit of a wireless communication area, but also as a term indicating the function of performing wireless communication with UEs 100.

The eNBs 200 have functions such as a radio resource management (RRM) function, a user data routing function, and a measurement control function for mobility control and scheduling.

The EPC 20 includes multiple MME/S-GWs (mobility management entity/serving-gateway) 300.

The MME is a network node for performing various types of control such as mobility control on the UEs 100, and corresponds to a control station. The S-GW is a network node for controlling the transfer of user data, and corresponds to a switching center. The EPC 20 constituted by the MME/S-GWs 300 houses the eNBs 200.

The eNBs 200 are connected to one another via interfaces X2. The eNBs 200 are also connected to the MME/S-GWs 300 via interfaces SI.

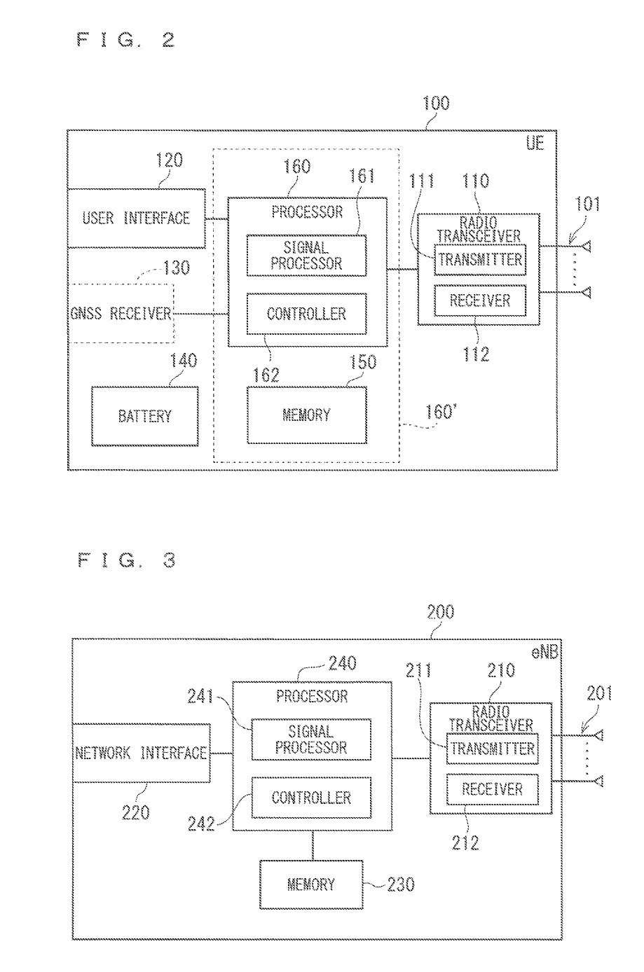

FIG. 2 illustrates a block diagram showing a configuration of a UE 100. As illustrated in FIG. 2, the UE 100 includes multiple antennas 101, a radio transceiver 110, a user interface 120, a global navigation satellite system (GNSS) receiver 130, a battery 140, a memory 150, and a processor 160. The UE 100 may not include the GNSS receiver 130. The memory 150 and the processor 160 may be integrated with each other, and this integrated set (i.e., chip set) may serve as a processor 160′.

The multiple antennas 101 and the radio transceiver 110 are used to transmit and receive radio signals. The radio transceiver 110 includes a transmitter 111 that can convert baseband signals (transmission signals) output from the processor 160 into radio signals and transmit the radio signals from the multiple antennas 101. The radio transceiver 110 also includes a receiver 112 that can convert radio signals received by the multiple antennas 101 into baseband signals (received signals) and output the baseband signals to the processor 160.

The user interface 120 is an interface with the user who holds the UE 100 and includes, for example, a display, a microphone, a speaker, and various types of buttons. The user interface 120 can accept user operation and output a signal that indicates the content of that operation to the processor 160.

The GNSS receiver 130 can receive GNSS signals and output the received signals to the processor 160 in order to obtain position information that indicates the geographical position of the UE 100. The battery 140 can store power that is supplied to each block of the UE 100.

The memory 150 can store programs to be executed by the processor 160 and information to be used in the processing performed by the processor 160. The processor 160 includes a signal processor 161 that can perform signal processing such as modulation, demodulation, encoding, and decoding of the baseband signals, and a controller 162 that can perform various types of control by executing the programs stored in the memory 150.

The signal processor 161 includes an analog transmission processor, in addition to a digital transmission processor, because channel state information (CSI) measured by the UE 100 is transmitted via analog feedback to an eNB 200 as will be described later.

The digital transmission processor can generate transmission signals, using a digital transmission system compliant with the current 3GPP standards.

The analog transmission processor can generate transmission signals, using an analog transmission system.

The processor 160 may further include a codec that can encode and decode sound and video signals. The processor 160 can perform various types of control, which will be described later.

FIG. 3 illustrates a block diagram showing a configuration of an eNB 200. As illustrated in FIG. 3, the eNB 200 includes multiple antennas 201, a radio transceiver 210, a network interface 220, a memory 230, and a processor 240. The memory 230 and the processor 240 constitute a base-station controller.

The multiple antennas 201 and the radio transceiver 210 are used to transmit and receive radio signals. The radio transceiver 210 includes a transmitter 211 that can convert baseband signals (transmission signals) output from the processor 240 into radio signals and transmit the radio signals from the multiple antennas 201. The radio transceiver 210 also includes a receiver 212 that can convert radio signals received by the multiple antennas 201 into baseband signals (received signals) and output the baseband signals to the processor 240.

The network interface 220 is connected to neighboring eNBs 200 via the interfaces X2 (FIG. 1) and connected to MME/S-GWs 300 via the interfaces SI (FIG. 1). The network interface 220 is used in the communication via the interfaces X2 and the communication via the interfaces SI.

The memory 230 can store programs to be executed by the processor 240 and information to be used in the processing performed by the processor 240. The processor 240 includes a signal processor 241 that can perform signal processing such as modulation, demodulation, encoding, and decoding of baseband signals, and a controller 242 that can perform various types of control by executing the programs stored in the memory 230. The processor 240 can perform various types of control, which will be described later.

The eNB 200 receives channel state information (CSI) transmitted via the analog transmission system. The signal processor 241 of the eNB 200 has a function of acquiring correlation between a received reference signal and a received analog signal and directly detecting target data. More specifically, the signal processor 241 of the eNB 200 has a function of equalizing the received analog signal with uplink channel state information obtained by the reference signal and detecting a value that indicates the equalized analog signal as target data.

FIG. 4 illustrates a wireless interface protocol stack in the LTE system. As illustrated in FIG. 4, wireless interface protocols are divided into Layers 1 to 3 of the OSI reference model. Layer 1 is a physical (PHY) layer. Layer 2 includes a media access control (MAC) layer, a radio link control (RLC) layer, and a packet data convergence protocol (PDCP) layer. Layer 3 includes a radio resource control (RRC) layer.

The physical layer performs encoding and decoding, modulation and demodulation, antenna mapping and demapping, and resource mapping and demapping. Between the physical layer of a UE 100 and the physical layer of an eNB 200, data is transmitted via a physical channel.

The MAC layer performs processing such as controlling data priority and performing re-transmission processing using hybrid ARQ (HARQ). Between the MAC layer of a UE 100 and the MAC layer of an eNB 200, data is transmitted via a transport channel. The MAC layer of the eNB 200 includes uplink and downlink transport formats (e.g., transport block sizes, and modulation and coding schemes (MCSs)) and a scheduler for determining allocated resource blocks.

The RLC layer transmits data to the RLC layer on the receiving side with use of the functions of the MAC layer and the physical layer. Between the RLC layer of a UE 100 and the RLC layer of an eNB 200, data is transmitted via a logical channel.

The PDCP layer performs header compression and decompression, and encryption and decryption.

The RRC layer is defined in only the control plane. Between the RRC layer of a UE 100 and the RRC layer of an eNB 200, a control message (RRC message) for making various types of settings is transmitted. The RRC layer controls the logic channel, the transport channel, and the physical channel in response to establishment, re-establishment, or release of a radio bearer. When there is an RRC connection between the RRC of the UE 100 and the RRC of the eNB 200, the UE 100 is in a connected state (RRC connected state), and otherwise the UE 100 is in an idle state (RRC idle state).

A non-access stratum (NAS) layer above the RRC layer performs processing such as session management and mobility management.

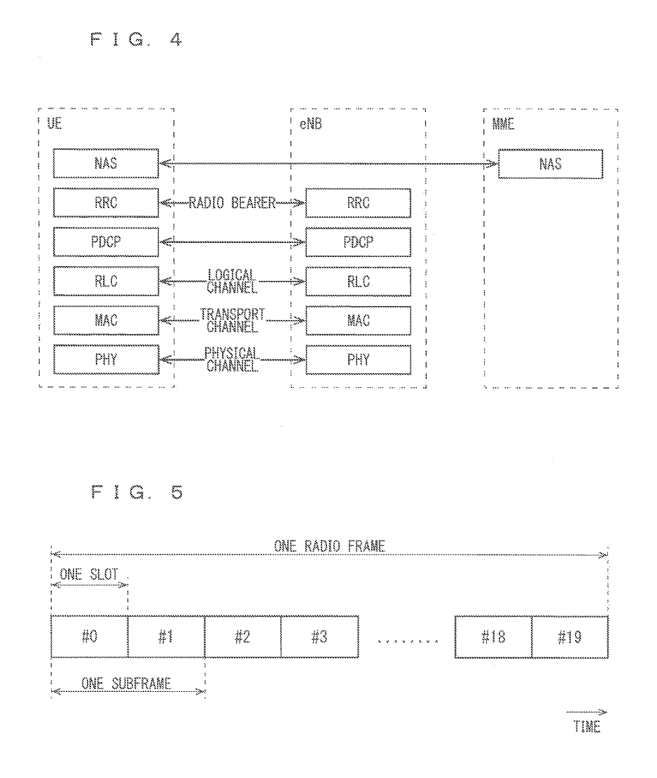

FIG. 5 illustrates the structure of a radio frame used in the LTE system. The LTE system applies orthogonal frequency division multiplexing access (OFDMA) to downlink and single carrier frequency division multiple access (SC-FDMA) to uplink.

As illustrated in FIG. 5, the radio frame consists of 10 subframes arranged in the time direction, and each subframe consists of two slots arranged in the time direction. Each subframe has a length of 1 msec, and each slot has a length of 0.5 msec. Each subframe includes multiple resource blocks (RB) in the frequency direction and multiple symbols in the time direction. Each resource block includes multiple subcarriers in the frequency direction. A radio resource unit consisting of a single subcarrier and a single symbol is referred to as a resource element (RE).

Among the radio resources allocated to the UE 100, frequency resources can be identified by resource blocks, and time resources can be identified by subframes (or slots).

In downlink, a section of the first several symbols of each subframe is a control region that is used as physical downlink control channel (PDCCH) for transmitting mainly control signals. The remaining section of the subframe is a region that is used as physical downlink shared channel (PDSCH) for transmitting mainly user data.

The PDCCH conveys control signals. The control signals include, for example, uplink scheduling information (SI), downlink SI, and TPC bits. The uplink SI is information indicating the allocation of uplink radio resources, and the downlink SI is information indicating the allocation of downlink radio resources. The TPC bits are information instructing that uplink transmission power be increased or reduced. These pieces of information are referred to as downlink control information (DCI).

The PDSCH conveys control signals and/or user data. For example, a downlink data region may be allocated to only user data, or may be allocated so that user data and control signals are multiplexed.

In downlink, each subframe is provided with a cell-specific reference signal (CRS) and a channel-state-information reference signal (CSI-RS) that are distributed in the subframe. Each of the CRS and the CSI-RS is configured by a predetermined orthogonal signal series. The eNBs 200 transmit the CRSs and the CSI-RSs from the multiple antennas 201.

In uplink, the opposite ends of each subframe in the frequency direction are control regions used as physical uplink control channel (PUCCH) for transmitting mainly control signals. The central part of the subframe in the frequency direction is a region used as physical uplink shared channel (PUSCH) for transmitting mainly user data.

The PUCCH conveys control signals. The control signals include, for example, a channel quality indicator (CQI), a precoding matrix indicator (PMI), a rank indicator (RI), a scheduling request (SR), and ACK/NACK.

The CQI is an index indicating downlink channel quality and is used to, for example, determine a recommended modulation system and a recommended coding rate that are to be used in downlink transmission. The PMI is an index indicating a precoding matrix that is desirably used in downlink transmission. The RI is an index indicating the number of layers (number of streams) available for downlink transmission. The SR is information that requires the allocation of uplink radio resources (resource blocks). The ACK/NACK is information indicating whether signals transmitted via a downlink physical channel (e.g., PDSCH) have been successfully decoded.

The CQI, the PMI, and the RI correspond to channel state information (CSI) obtained by the UE 100 estimating a channel with use of the downlink reference signals (CRS and/or CSI-RS).

The PUSCH conveys control signals and/or user data. For example, an uplink data region may be allocated to only user data, or may be allocated so that user data and control signals are multiplexed.

In uplink, a predetermined symbol of each subframe is provided with a sounding reference signal (SRS) and a demodulation reference signal (DMRS). Each of the SRS and the DMRS is configured by a predetermined orthogonal signal series.

Embodiments will now be described, taking the example of the case where embodiments are applied to the LTE, which is described above with reference to FIGS. 1 to 5.

### Embodiment 1

The UEs 100 use analog transmission systems to feed back measured channel state information (CSI) to the eNBs 200. Thus, as described previously, transmission errors caused by noise or interface in uplink may not be corrected, and the reliability of the CSI received by the eNBs 200 depends on channel quality (e.g., noise level).

In one embodiment, the eNBs 200 estimate the channel quality of a channel used in CSI feedback and select a codebook (an aggregate of transmission antenna weight candidates) for performing weighting (pre-coding) of transmission signals on the basis of the estimated channel quality.

The CSI feedback from the UE 100 is usually implemented using the physical uplink control channel (PUCCH) or the physical uplink shared channel (PUSCH), and the channel quality of these channels are estimated.

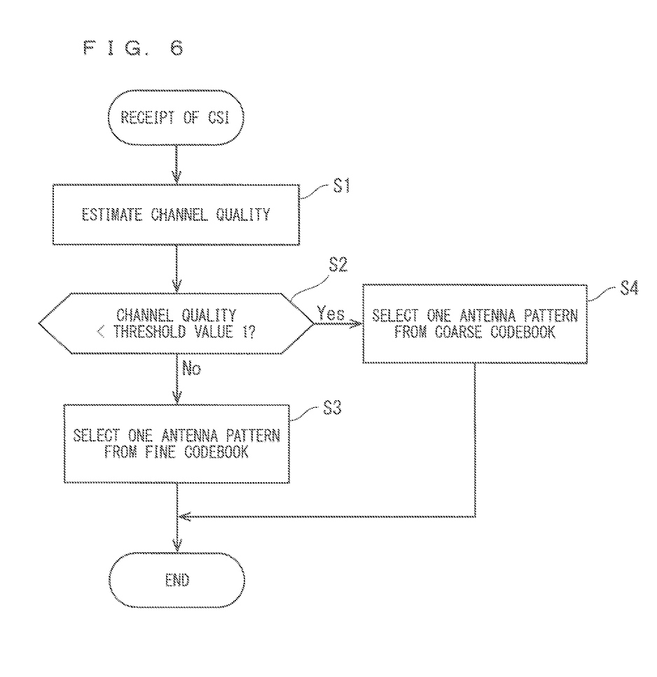

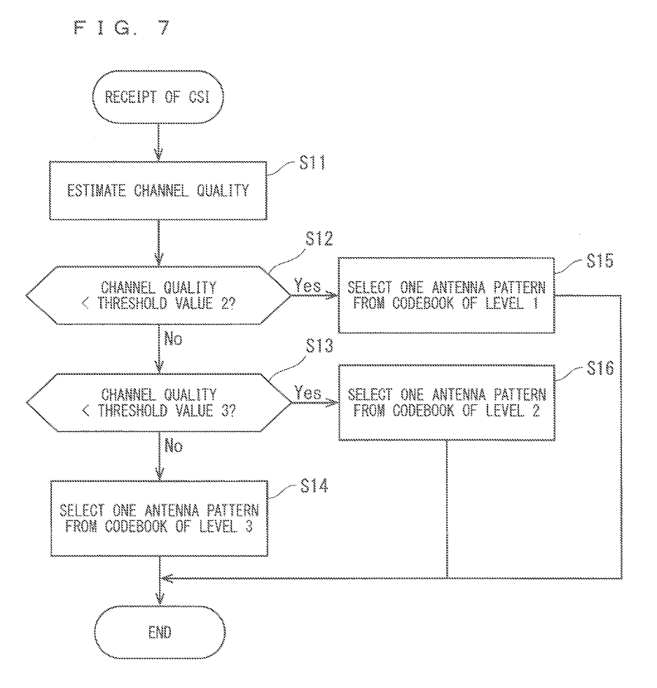

FIG. 6 illustrates a flowchart for describing the operation of controlling weighting on the basis of an estimated value of channel quality according to Embodiment 1.

As illustrated in FIG. 6, upon receipt of CSI feedback from the UE 100, an eNB 200 estimates the channel quality of a channel used in the CSI feedback (step S1). The channel quality is defined by the signal-to-interference-plus-noise ratio (SINR) or the signal-to-noise ratio (SNR), and the channel quality of the PUSCH and the PUCCH may be estimated using a sounding reference signal (SRS) and/or a demodulation reference signal (DMRS). It is also conceivable that the channel quality of the PUCCH is estimated in an auxiliary manner from the degree of congestion of cells managed by the eNB 200 itself.

Next, the estimated value of the channel quality is compared with a predetermined threshold value (for the sake of convenience, referred to as “threshold value 1”) (step S2). If the estimated value of the channel quality is less than threshold value 1, the procedure proceeds to step S4, and if the estimated value of the channel quality is greater than or equal to threshold value 1, the procedure proceeds to step S3. When the SINR is used to define the channel quality, threshold value 1 may be set to, for example, 5 dB.

If two codebooks with different levels of granularity are prepared in advance and the procedure proceeds to step S3, i.e., the estimated value of the channel quality is greater than or equal to threshold value 1, a transmission antenna weight for generating a single antenna pattern is selected from the codebook with finer granularity (fine codebook) on the basis of the received CSI. Since the transmission antenna weight is a value that implements an antenna pattern, the following description is given on the assumption that the transmission antenna weight is synonymous with the antenna pattern.

On the other hand, if the procedure proceeds to step S4, i.e., if the estimated value of the channel quality is less than threshold value 1, a single antenna pattern is selected from the codebook with coarser granularity (coarse codebook) on the basis of the received CSI. The operation of selecting a single antenna pattern from the selected codebook is conventionally known, and description thereof will be omitted.

Although steps S1 to S4 are followed by the step of performing weighting using the selected signal antenna weight, this step is a well-known step, and illustration and description thereof will be omitted.

In this way, a codebook is selected on the basis of the estimated channel quality, and a single antenna pattern selected from the selected codebook is used in downlink transmission to the UE 100 (corresponding UE 100) from which the analog feedback of the CSI was given. This allows transmission signals to be transmitted without loss in quality and without reducing the transmission performance of the eNB 200.

In poor channel-quality conditions, the CSI that is fed back from the UE 100 may have low reliability. Thus, in poor channel-quality conditions, even if an antenna pattern selected from a fine codebook is used in downlink transmission from the eNB 200 to the corresponding UE 100, it is highly likely that the corresponding UE 100 may not be able to receive transmission signals. More simply, although a finer codebook includes more highly directional antenna patterns, even if transmission using such a highly directional antenna pattern is conducted in poor channel-quality conditions, it is highly likely that the corresponding UE 100 may not be able to receive transmission signals or that the quality of transmission signals may be low.

Thus, in poor channel-quality conditions, an antenna pattern selected from a coarse codebook is used in transmission. This improves the probability of receipt of transmission signals at the corresponding UE 100 and allows transmission signals to be transmitted without loss in quality and without reducing the transmission performance of the eNB 200.

In the disclosure, the term “level of granularity” is used as a language that comprehensively represents the definition or precision of the beam width or resolution of an antenna pattern (transmission antenna weight), and is also used to comprehensively represent the resolution or definition of multiple antenna patterns included in a codebook.

Thus, a “codebook with fine granularity” means that the antenna patterns included in the codebook have narrow and sharp beam widths or have high resolution, and a “codebook with coarse granularity” means that the antenna patterns included in the codebook have wide and board beam widths or have low resolution.

For example, in order to cover the entire circumference in a plane, a 4-bit codebook including 16 antenna patterns can be said to have higher resolution and finer granularity than a 2-bit codebook including 4 antenna patterns. However, when compared with a 8-bit codebook including 256 antenna patterns, both of the 4-bit codebook including 16 antenna patterns and the 2-bit codebook including 4 antenna patterns have low resolution and coarser granularity.

Thus, for example when the fine codebook in step S3 is a 4-bit codebook including 16 antenna patterns, the coarse codebook in step S4 is one of a 2-bit codebook including 8 antenna patterns, a 2-bit codebook including 4 antenna patterns, and a 1-bit codebook including 2 antenna patterns.

As a more specific example, the coarse codebook in step S4 may be a codebook including 16 antenna patterns, disclosed in Table 6.3.4.2.3-2 of the TS36.211 (V12.1.0) LTE specification, and the fine codebook in step S3 may be a codebook including 256 antenna patterns, disclosed in, for example, Tables 7.2.4-0A and 7.2.4-0B of the TS36.213 (V12.1.0) LTE specification.

Variations

While Embodiment 1 described above takes the example of the configuration in which two codebooks with different levels of granularity are prepared in advance, and one of the codebooks is selected on the basis of the estimated channel quality, the number of codebooks is not limited to two, and a configuration is also possible in which multiple threshold values are set for channel quality and a larger number of codebooks with different levels of granularity are used as targets for selection.

One example will now be described with reference to FIG. 7. FIG. 7 illustrates a flowchart for describing the operation of controlling weighting performed when two types of threshold values are set for channel quality, and three codebooks with different levels of granularity are used as targets for selection.

As illustrated in FIG. 7, upon receipt of CSI feedback from a UE 100, an eNB 200 estimates the channel quality of a channel used in the CSI feedback (step S11).

Next, the estimated value of the channel quality is compared with a predetermined first threshold value (for the sake of convenience, referred to as “threshold value 2”) (step S12). If the estimated value of the channel quality is less than threshold value 2, the procedure proceeds to step S15, and if the estimated value of the channel quality is greater than or equal to threshold value 2, the procedure proceeds to step S13. When the SINR is used to define the channel quality, threshold value 2 may be set to, for example, 5 dB.

If three codebooks with different levels of granularity from Level 1 (coarse) to Level 3 (fine) of granularity are prepared in advance and the procedure proceeds to step S15, i.e., the estimated value of the channel quality is less than threshold value 2, a single antenna pattern is selected from the codebook of Level 1 on the basis of the received CSI.

On the other hand, if the procedure proceeds to step S13, i.e., if the estimated value of the channel quality is greater than or equal to threshold value 2, the estimated value of the channel quality is compared with a predetermined second threshold value (for the sake of convenience, referred to as “threshold value 3”). If the estimated value of the channel quality is less than threshold value 3, the procedure proceeds to step S16, and if the estimated value of the channel quality is greater than or equal to threshold value 3, the procedure proceeds to step S14.

When the SINR is used to define the channel quality, threshold value 3 is set to, for example, 10 dB.

If the procedure proceeds to step S16, i.e., if the estimated value of the channel quality is less than threshold value 3, a single antenna pattern is selected from the codebook of Level 2 on the basis of the received CSI.

On the other hand, if the procedure proceeds to step S14, i.e., if the estimated value of the channel quality is greater than or equal to threshold value 3, a single antenna pattern is selected from the codebook of Level 3 on the basis of the received CSI.

It is assumed here that the codebook of Level 1 in step S15 is a 3-bit codebook including 8 antenna patterns, and the codebook of Level 2 in step S16 is a 4-bit codebook including 16 antenna patterns. The codebook of Level 3 in step S14 is an 8-bit codebook including 256 antenna patterns.

Although steps S11 to S16 are followed by the step of performing weighting using the selected single antenna weight, this step is a well-known step and illustration and description thereof will be omitted.

In this way, weighting is performed using the three codebooks with different levels of granularity as targets for selection. This allows the channel quality to be classified into more detailed categories.

While Embodiment 1 and variations thereof described above take the example of the case in which codebooks disclosed in the LTT specification are used as examples of the codebooks with different levels of granularity, a codebook that implements multiple antenna patterns with different beams widths may be used as the codebooks with different levels of granularity.

While the technique for controlling the beam width is common knowledge, other techniques such as massive MIMO and massive antenna array that are recently being developed may also be used.

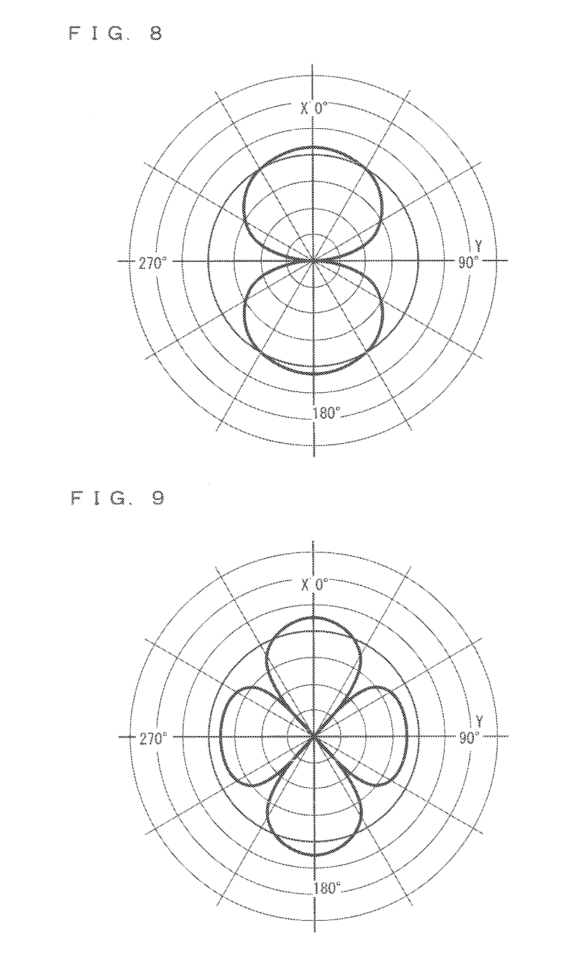

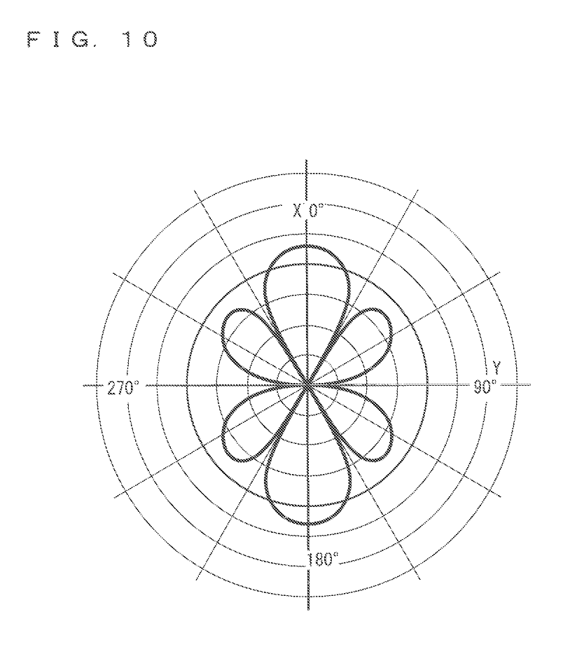

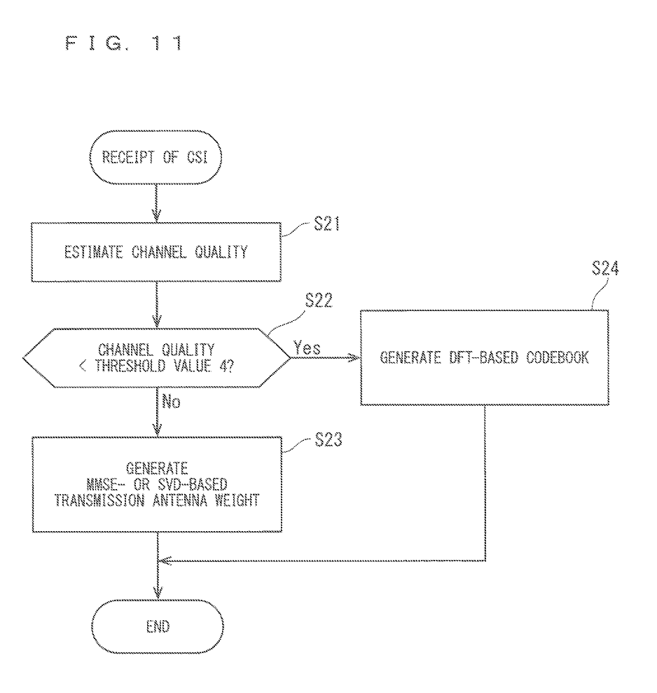

FIGS. 8 to 10 schematically illustrate examples of antenna patterns with different beam widths. FIG. 8 illustrates an example of a coarse antenna pattern with the largest beam width. FIG. 9 illustrates an example of a medium-grain antenna pattern with a beam width smaller than the beam width of the antenna pattern in FIG. 8. FIG. 10 illustrates an example of a fine antenna pattern with the smallest beam width.

Note that the operation of controlling weighting on the basis of the estimated value of the channel quality, which is described with reference to FIGS. 6 and 7, is an operation performed by the controller 242 of the processor 240 of the eNB 200.

### Embodiment 2

While Embodiment 1 and variations thereof described above employ the configuration in which the eNB 200 estimates the channel quality of a channel used in CSI feedback and selects one of the previously prepared codebooks on the basis of the estimated channel quality, a configuration is also possible in which a codebook or a transmission antenna weight (antenna pattern) is generated in real time on the basis of the estimated channel quality, instead of preparing codebooks in advance.

In this case, codebooks or transmission antenna weights with different levels of granularity may be generated by selecting a calculation method (algorithm) for generating a codebook or a transmission antenna weight.

The algorithm for generating a transmission antenna weight is common knowledge, and one example is a method of generating a high-precision (fine) transmission antenna weight with use of a minimum mean squared error (MMSE)-based or singular value decomposition (SVD)-based algorithm using a matrix such as a channel matrix, a channel correlation matrix, or a channel covariance matrix as an example of the CSI. Also, one example of the method of generating a coarse codebook such as a 4-bit codebook including 16 antenna patterns is a method using a discrete-Fourier-transform (DFT)-based algorithm.

The LTE standardized by the 3GPP uses codebooks generated by a codebook generation method using a DFT-based algorithm. The DFT-based codebook generation method is common knowledge, and is also disclosed in Section III-B of “Performance Comparison of Limited Feedback Codebook-Based Downlink Beamforming Schemes for Distributed Antenna Systems,” by V. U. Prabhu, S. Karachontzitis, and D. Toumpakaris in Wireless Communication, Vehicular Technology, Information Theory and Aerospace & Electronic Systems Technology, 2009 (hereinafter, “Document Prabhu”).

The features of the DFT-based codebook generation method include simple calculation, quick calculation time, and the ability to generate a codebook from simple CSI information (e.g., information such as indices), which allows codebooks to be generated and prepared in advance. The codebooks used in Embodiment 1 and variations thereof may be prepared in advance by this method.

The MMSE-based transmission-antenna-weight generation method is a standard generation method for cancelling interference, and the SVD-based transmission-antenna-weight generation method uses a standard algorithm for implementing MIMO communication. It is necessary in the MMSE-based transmission-antenna-weight generation method and the SVD-based transmission-antenna-weight generation method to feed back a channel matrix or a channel covariance matrix as CSI information.

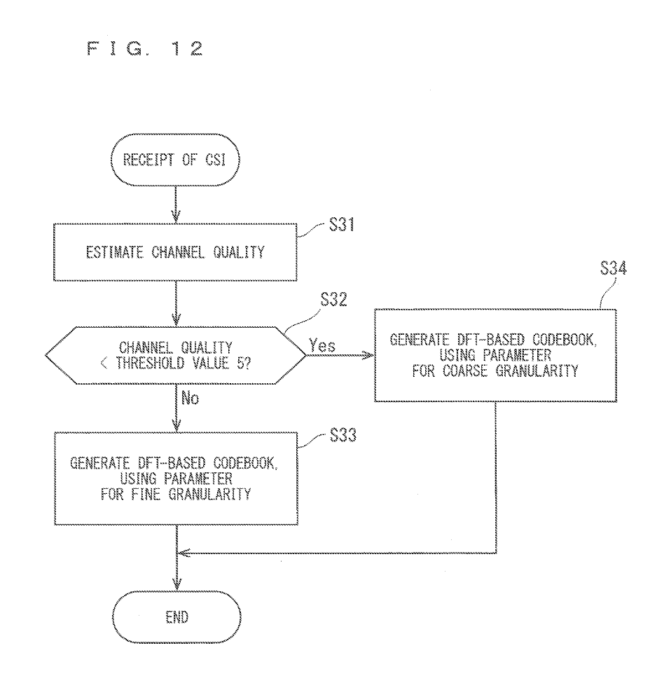

FIG. 11 illustrates a flowchart for describing the operation of controlling weighting on the basis of an estimated value of channel quality according to Embodiment 2.

As illustrated in FIG. 11, upon receipt of CSI feedback from the UE 100, the eNB 200 estimates the channel quality of a channel used in the CSI feedback (step S21).

Next, the estimated value of the channel quality is compared with a predetermined threshold value (for the sake of convenience, referred to as “threshold value 4”) (step S22). If the estimated value of the channel quality is less than threshold value 4, the procedure proceeds to step S24, and if the estimated value of the channel quality is greater than or equal to threshold value 4, the procedure proceeds to step S23. When the SINR is used to define the channel quality, threshold value 4 is set to, for example, 5 dB.

If the procedure proceeds to step S23, i.e., if the estimated value of the channel quality is greater than or equal to threshold value 4, a fine transmission antenna weight is generated by the MMSE- or SVD-based transmission-antenna-weight generation method. Here, a “transmission antenna weight with fine granularity” means that the antenna pattern generated by the transmission antenna weight has high resolution, and a “transmission antenna weight with coarse granularity” means that the beam width and resolution generated by the transmission antenna weight is low. On the other hand, if the procedure proceeds to step S24, i.e., if the estimated value of the channel quality is less than threshold value 4, a coarse transmission antenna weight is generated by the DFT-based codebook generation method.

Although steps S21 to S24 are followed by the step of performing weighting using the generated single transmission antenna weight, this step is a well-known step, and illustration and description thereof will be omitted.

In this way, a calculation method for generating a transmission antenna weight is selected on the basis of the estimated channel quality, and a single antenna pattern (transmission antenna weight) generated by the selected calculation method is used in downlink transmission to the UE 100 (corresponding UE 100) from which the analog feedback of the CSI was given. This allows transmission signals to be transmitted without loss in quality and without reducing the transmission performance of the eNB 200.

Note that the operation of controlling weighting on the basis of the estimated value of the channel quality, which is described with reference to FIG. 11, is an operation performed by the controller 242 of the processor 240 of the eNB 200.

### Embodiment 3

While Embodiment 2 described above employs the configuration in which transmission antenna weights with different levels of granularity are generated by selecting a calculation method for generating a transmission antenna weight on the basis of the estimated channel quality, codebooks with different levels of granularity may be generated by adjusting a parameter of the calculation method for generating a codebook.

For example, in a DFT-based codebook generation method, the level of granularity can be adjusted by adjusting a parameter that represents the number of antenna patterns, which will be described below.

The LTE standardized by the 3GPP uses codebooks generated by the DFT-based codebook generation method. Here, the DFT-based codebook generation method is described on the basis of the content described in Section III-B of Document Prabhu given above.

In Document Prabhu described above, T_{dft} is defined by Equation (1) below, where T_{dft} is a single codebook vector (corresponding to an antenna pattern) in a codebook.

T_{dft}=[D_{dft}⁰F,D_{dft}¹F, . . . ,D_{dft}^{Ni}F] (1)

In Equation (1), Daft is the diagonal matrix, Nₜ is the number of antennas, Nᵢ=N/Nₜ, and N is the number of necessary antenna patterns.

A Fourier function F (k, l) is defined by Equation (2) below.

$$F ( k .1 ) = \frac{1}{\sqrt{{N}_{t}}} {e}^{\{ \frac{2 π k 1}{{N}_{t}} \}} ; F ∈ {C}^{{N}_{t} {N}_{t}} and {D}_{dft} ∈ {C}^{{{N}_{t} {N}_{t}}^{15}} \qquad ( 2 )$$

According to Equation (2), codebooks with different levels of granularity can be generated by adjusting the setting of N (number of antenna patterns).

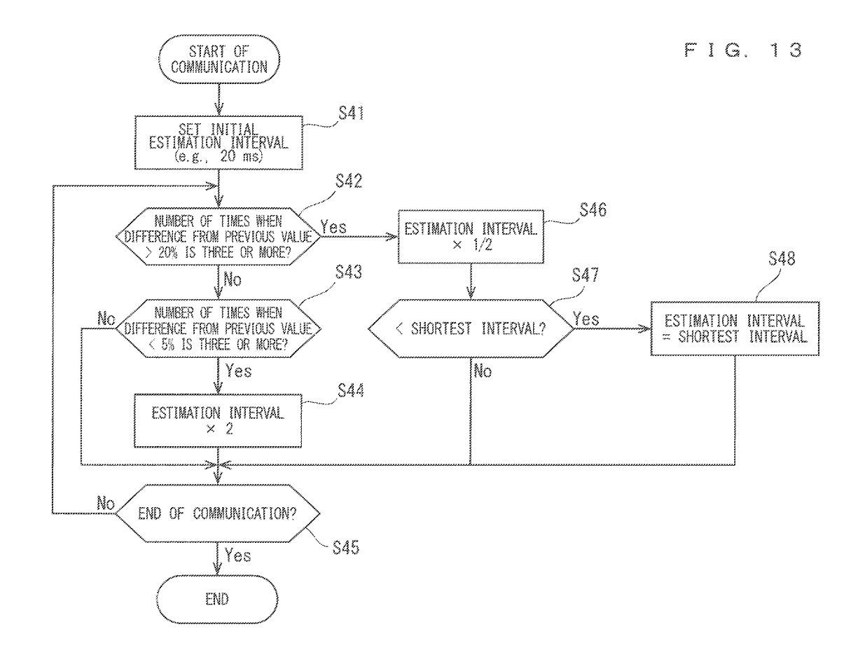

FIG. 12 illustrates a flowchart for describing the operation of controlling weighting on the basis of the estimated value of the channel quality according to Embodiment 3.

As illustrated in FIG. 12, upon receipt of CSI feedback from a UE 100, an eNB 200 estimates the channel quality of a channel used in the CSI feedback (step S31).

Next, the estimated value of the channel quality is compared with a predetermined threshold value (for the sake of convenience, referred to as “threshold value 5”) (step S32). If the estimated value of the channel quality is less than threshold value 5, the procedure proceeds to step S34, and if the estimated value of the channel quality is greater than or equal to threshold value 5, the procedure proceeds to step S33. When the SINR is used to define the channel quality, threshold value 5 is set to, for example, 5 dB.

If the procedure proceeds to step S33, i.e., if the estimated value of the channel quality is greater than or equal to threshold value 5, a DFT-based transmission antenna weight is generated using a parameter for fine granularity. On the other hand, if the procedure proceeds to step S34, i.e., if the estimated value of the channel quality is less than threshold value 5, a DFT-based transmission antenna weight is generated using a parameter for coarse granularity.

Although steps S31 to S34 are followed by the step of performing weighting using the generated signal transmission antenna weight, this step is a well-known step, and illustration and description thereof will be omitted.

In this way, a codebook is generated on the basis of the estimated channel quality, and an antenna pattern included in the codebook is used in downlink transmission to the UE 100 (corresponding UE 100) from which analog feedback of the CSI was given. This allows transmission signals to be transmitted without loss in quality and without reducing the transmission performance of the eNB 200.

Note that the operation of controlling weighting on the basis of the estimated value of the channel quality, which is described with reference to FIG. 12, is an operation performed by the controller 242 of the processor 240 of the eNB 200.

Variations

While Embodiment 3 described above takes the example of the configuration in which the level of granularity of the DFT-based codebook is adjusted by parameter adjustment, the levels of granularity of MMSE- and SVD-based codebooks may also be controlled by adjusting parameters for adjusting the level of granularity.

Timing of Estimating Channel Quality

Although the timing of estimating the channel quality is not particularly referred to in Embodiments 1 to 3 described above, the timing of estimating the channel quality desirably coincides with the timing of receiving the CSI (same subframe). Thus, the channel quality is desirably estimated simultaneously with the receipt of the CSI as illustrated in the flowcharts in FIGS. 6, 7, 11, and 12, but may be estimated independently of the receipt of the CSI.

That is, in the case where the channel quality is periodically estimated at fixed intervals during a communication session and the result of the estimation of the channel quality is used, i.e., weighting is performed upon receipt of the CSI, the latest estimation result may be used.

For example, in the case where the feedback of the CSI is periodic, the channel quality may be estimated at the time immediately before the feedback of the CSI. When the feedback of the CSI is non-periodic, the channel quality may be estimated at the time immediately before the transmission of a request for the CSI from the eNB 200 to the UE 100.

Alternatively, when there is no need to frequently estimate the channel quality, the interval of estimation of the channel quality may be set as desired. For example, the interval of estimation may be set to 20 msec, and in the case where CSI feedback is received from a UE that shows a rapid change in the transmission line, the interval of estimation may be set to, for example, 10 msec, 5 msec, or 2 msec.

As another alternative, the interval of estimation may be dynamically adjusted in accordance with the rate of change of the channel quality as described below.

FIG. 13 illustrates a flowchart for describing a method of dynamically adjusting the interval of channel estimation. As illustrated in FIG. 13, when a communication session between an eNB 200 and a UE 100 is started, the initial estimation interval is set to, for example, 20 msec (step S41).

Then, the channel estimation is repeated at an interval of 20 msec, and whenever the channel estimation is conducted, the difference between the new estimated value and the previous estimated value is calculated and it is determined whether the difference between the new estimated value and the previous estimated value exceeds 20% (step S42). If the number of cases where the difference exceeds 20% reaches three or more within a predetermined period of time, the procedure proceeds to step S46, and otherwise the procedure proceeds to step S43.

Here, the case in which the number of cases where the difference exceeds 20% reaches three or more within a predetermined period of time indicates the case where a cumulative total of the number of cases where the difference exceeds 20% reaches three or more within a period of time that corresponds to, for example, five times the currently set estimation interval (i.e., within a period of time required to conduct the estimation five times). If the estimation interval is, for example, the initial set value of 20 msec, the number of cases where the difference exceeds 20% reaches three or more within a period of time that corresponds to five times the initial estimation interval (100 msec).

If the procedure proceeds to step S46, i.e., if the number of cases where the difference exceeds 20% reaches three or more within the predetermine period of time, it can be said that the channel quality greatly changes at frequent intervals, and therefore the estimation interval is halved to check the rate of change of the channel quality.

The procedure then proceeds to step S47, in which it is determined whether the changed estimation interval is shorter than a shortest interval. If it is determined that the changed estimation interval is shorter than the shortest interval, the estimation interval is set to the shortest interval (step S48), and the procedure proceeds to step S45. The shortest interval as used herein refers to the shortest time interval of CSI feedback defined by the LTE specification. For example, when the shortest duration of CSI feedback is one subframe, the shortest estimation interval is 1 msec.

On the other hand, if it is determined that the changed estimation interval is longer than or equal to the shortest interval, the changed estimation interval remains unchanged and the procedure proceeds to step S45.

If the procedure proceeds from step S42 to step S43, i.e., if the number of cases where the difference exceeds 20% does not reach three within the predetermined period of time, it is determined in step S43 whether the number of cases where the difference between the new estimated value and the previous estimated value is less than 5% reaches three or more within a predetermined period of time. This is the operation of confirming that the channel quality does not change very much, rather than changing greatly so that the difference between the new estimated value and the estimated value exceeds 20%.

The predetermined period of time as used herein is the same as the predetermined period of time used in the case of determining whether the difference exceeds 20%. That is, two determinations as to whether the difference between the new estimated value and the previous estimated value exceeds 20% and whether the difference is less than 5% are made within the same predetermined period of time.

If the number of cases where the difference is less than 5% reaches three or more within the predetermined period of time, the procedure proceeds to step S44, and otherwise the procedure proceeds to step S45.

If the procedure proceeds to step S44, i.e., if the number of cases where the difference is less than 5% reaches three or more within the predetermined period of time, it can be said that the channel quality does not change at frequent intervals, and there is no need to frequency check whether the channel quality has changed. Accordingly, the estimation interval is doubled, and the procedure proceeds to step S45.

In step S45, it is determined whether the currently proceeding communication session has ended. If the communication session has ended, the control of the dynamic adjustment of the channel estimation interval also ends. On the other hand, if the communication session has not yet ended, the processing of step S42 onward is repeated.

If the procedure proceeds from step S42 to step S43 and then from step S43 to step S45, i.e., if the estimation interval has not been changed within the predetermined period of time, a value that corresponds to the oldest estimated value is discarded from the count value of the number of times recorded, and a value that corresponds to a new estimated value obtained after the elapse of the estimation interval is counted. Alternatively, all of the count values (e.g., five) of the number of times recorded may be discarded to reset the recording, and the number of times may be recorded again within the predetermined period of time.

The aforementioned difference (e.g., 20% or 5%) between the new estimated value and the previous estimated value is merely one example, and it goes without saying that the difference may be changed from 20% to 15% or from 5% to 3%, for example.

The number of times (three) that the difference between the new estimated value and the previous estimated value exceeds or becomes less than the predetermined value within the predetermined period of time is also merely one example, and it goes without saying that the number of times may be set to other values such as two or five.

The aforementioned method of dynamically adjusting the interval of channel estimation is also applicable to both of the cases where the channel estimation is conducted simultaneously with the receipt of the CSI and where the channel estimation is conducted independently of the receipt of the CSI.

Note that the operation of dynamically adjusting the channel estimation interval described with reference to FIG. 15 is an operation performed by the controller 242 of the processor 240 of the eNB 200.

Correction of CSI

While the above descriptions of Embodiments 1 to 3 are given on the assumption that codebooks are adjusted (generated, selected) on the basis of the channel quality of the channel used in the CSI feedback and the CSI that is fed back, it is also conceivable to adjust the CSI when the result of estimation of the channel quality shows low channel quality of the channel used in the CSI feedback.

For example, when the CSI is a CQI, adjustment is made to reduce the index of the CQI. Such adjustment facilitates downlink receipt, maintaining constant transmission performance even if the accuracy of the CSI is low.

In view of Embodiments 1 to 3 described above, it can be said that the disclosure is based on the technical idea of performing weighting of transmission signals by switching among multiple methods of generating a transmission antenna weight on the basis of the estimated channel quality.

### APPLICABILITY OF DISCLOSURE

While the above description takes the example of the case of feeding back the CSI (CQI, PMI, RI) for the sake of convenience of description, the application of the disclosure is not limited to this example, and the disclosure is also applicable to the case where information such as SINR, channel characteristic values, a channel matrix, and a channel covariance matrix is transmitted via analog feedback. Also, the application of the disclosure is not limited to the LTE, and the disclosure may be applied to systems other than the LTE system.

Note that embodiments of the disclosure may be freely combined or appropriately modified or omitted within the scope of the disclosure.

1. A wireless communication device for performing communication with a controlled wireless communication device, comprising:
at least one processor configured to estimate channel quality of a channel that is used in feedback of a signal from the controlled wireless communication device and control weighting of a transmission signal in consideration of the estimated channel quality,
the at least one processor being configured to store a plurality of methods of generating a transmission antenna weight that is used in the weighting of the transmission signal and perform the weighting of the transmission signal by switching among the plurality of methods of generating a transmission antenna weight on the basis of the estimated channel quality.

2. The wireless communication device according to claim 1, wherein
transmission antenna weights generated respectively by the plurality of methods of generating a transmission antenna weight have different levels of granularity, the levels of granularity being defined by at least one of beam widths and resolution of antenna patterns that are generated using the transmission antenna weights, and
the at least one processor is configured to use a method of generating a transmission antenna weight with relatively coarse granularity when the channel quality is relatively low, and use a method of generating a transmission antenna weight with relatively fine granularity when the channel quality is relatively high.

3. The wireless communication device according to claim 2, wherein
the at least one processor is configured to prepare a plurality of sets of aggregate of transmission antenna weight candidates in advance.

4. The wireless communication device according to claim 2, wherein
the at least one processor is configured to generate a transmission antenna weight candidate on the basis of the estimated channel quality.

5. The wireless communication device according to claim 4, wherein
the at least one processor is configured to:
select a parameter of a calculation method for generating a transmission antenna weight candidate on the basis of the estimated channel quality and perform the weighting of the transmission signal by using the transmission antenna weight candidate generated by the selected parameter;
when the channel quality is relatively low, select the parameter to generate a transmission antenna weight candidate with the relatively coarse granularity; and
when the channel quality is relatively high, select the parameter to generate a transmission antenna weight candidate with the relatively fine granularity.

6. The wireless communication device according to claim 1, wherein
the at least one processor is configured to:
when the channel quality is relatively low, select a discrete Fourier transform-based calculation method to generate a transmission antenna weight candidate; and
when the channel quality is relatively high, use a least squares error-based calculation method or a singular value decomposition-based calculation method to generate the transmission antenna weight candidate.

7. The wireless communication device according to claim 1, wherein
the at least one processor is configured to dynamically adjust an interval of estimation of the channel quality in accordance with a rate of change of the channel quality.

8. The wireless communication device according to claim 1, wherein
the feedback from the controlled wireless communication device is implemented using an analog transmission system for transmitting the signal without performing quantization and binary coding.

9. A method of controlling signal processing performed by a wireless communication device for performing communication with a controlled wireless communication device, the method comprising the steps of:
(a) estimating channel quality of a channel that is used in feedback of a signal from the controlled wireless communication device; and
(b) performing weighting of a transmission signal in consideration of the estimated channel quality,
the step (b) involving using a plurality of methods of generating a transmission antenna weight that is used in the weighting of the transmission signal, and performing the weighting of the transmission signal by switching among the plurality of methods of generating a transmission antenna weight on the basis of the estimated channel quality.
